(19) United States
(12) Patent Application Publication
(10) Pub. No.: US 2005/0017386 A1
(43) Pub. Date: Jan. 27, 2005

(54) Device and method for producing a product by free form forming

(76) Inventor: Urban Harrysson, Kullavik (SE)

Correspondence Address: YOUNG & THOMPSON, 745 SOUTH 23RD STREET, 2ND FLOOR, ARLINGTON, VA, 22202, US

(21) Appl. No.: 10/866,190

(22) Filed: Jun. 14, 2004

Related U.S. Application Data
(63) Continuation of application No. PCT/SE02/02307, filed on Dec. 11, 2002.

(30) Foreign Application Priority Data
Dec. 13, 2001 (SE) 0104237-3

(51) Int. Cl. B29C 31/00

(52) U.S. Cl. 264/40.1; 264/113; 425/375

(57) ABSTRACT

Device and method for manufacturing a product from a base material. The device includes a means for applying superimposed layers of base material (3) on a support (1), and a member (4) for binding together the base material in selected portions of the base material in order to form a continuous product from the base material, wherein the support, and thereby the base material, and the binding member are arranged in a mutually displaceable way in order to transfer energy to and/or deposit a medium in different positions of the base material by means of the binding member. Furthermore, the device includes a unit (17) for detecting errors in the binding member (4) and a means (18) for compensating for such errors, on the basis of detected errors, in subsequent energy transfer to and/or deposition on the base material (3).

### FIELD OF THE INVENTION AND PRIOR ART

The present invention relates to a device for manufacturing a product from a base material, including a means for applying superimposed layers of base material on a support and a member for binding together the base material in selected portions of the base material in order to form a continuous product from the base material, wherein the support, and thereby also the base material, and the binding member are arranged in a mutually displaceable way in order to transfer energy to and/or deposit a medium in different positions of the base material by means of the binding member. Furthermore, the invention relates to a method for manufacturing a product from a base material, comprising to apply layers of base material on top of each other, to bind together the base material in selected portions of the same into a continuous product by means of using a binding member, and to displace the base material and the binding member mutually in accordance with a selected motion pattern in order to transfer energy to and/or deposit a medium in different positions of the base material by means of the binding member.

The invention is applicable when manufacturing many different types of products, but in the following the application of manufacturing so-called FFF-articles (Free Form Fabrication), wherein powder granules are bonded into a solid product, will be described in an exemplifying but non-limiting way.

Production of FFF-articles can be done by means of depositing a powdered base material in thin layers and binding those portions which are to form the product. Accordingly, this implies that each base material layer can be said to constitute a cross section of the product. By means of binding together the powder within each respective layer and between the layers, a three-dimensional product is created by a number of layers. Different layers exhibiting different geometries and/or dimensions of the portions in question are bonded together in order to obtain the desired shape of the final product. Thereafter, the finished product is cleared of surrounding non-bonded base material.

Thereby, the binding of the base material can be performed by means of supplying a medium, usually a liquid binding agent, and/or transferring heat to those portions of the base material which are to be bonded together. There is also a possibility to add a medium which in itself is not capable of binding the base material together, but which makes it possible to bind together the base material in those portions which have been prepared with the medium in a subsequent treatment, e.g. heat supply.

A binding member is used for distributing the medium, or transferring energy to the portions in question of the base material and, in the first-mentioned case, suitably a depositing member such as e.g. a controlled printhead which is displaced in relation to the base material while the medium is emitted from a plurality of nozzles of the printhead onto the desired positions. It is very important that this deposition of the medium occurs in such a way that no continuous defects, i.e. non-bonded areas, are created in the finished article. Even a non-bonded volume with a very small extension in one dimension may imply that the article obtains a structural strength which is far too low because of the non-bonded volume being present as a through crack.

Printheads which are utilised for printouts on paper solve the problem of avoiding errors, i.e. a deficient printing as a result of one or several nozzles of the printhead being out of operation, by means of performing the printing motion a plurality of times in substantially the same positions while the printhead is displaced a relatively small distance. The magnitude of the distance or displacement can be defined in relation to the printing resolution, i.e. the pitch with which it is possible to print. Such a displacement is equivalent to approximately one pitch, up to a few hundred pitches between each printing motion. This will be done independent of whether errors exist or not, and independent of the position of such errors, in such a way that the likelihood of a sufficiently high print quality becomes as desired.

However, especially for two reasons, the above mentioned general error compensation method utilised in e.g. inkjet printers or electrostatic printers for paper printouts is no good when manufacturing FFF-articles:
1. The quantity of applied binding agent is often of a vital importance for the quality of the finished product, which means that an arbitrary number of depositions cannot be performed in order to ensure that non-bonded areas do not arise, and
2. The method tends to be unable to compete with other manufacturing methods if the time which is consumed for the deposition of e.g. a binding agent exceeds a certain value, which is the reason why it is desirable to minimise the number of depositions while maintaining the required quality.

If the applied quantity of binding agent becomes too large, the finished article can obtain a defective shape, e.g. as a result of lateral leakage. If, on the other hand, the quantity of binding agent becomes too small, the bonded areas might become too small and non-bonded gaps may arise between the areas.

### OBJECT OF THE INVENTION AND SUMMARY OF THE INVENTION

A first object of the invention is to provide a device of the type defined by way of introduction, which device enables defects in the finished product to be predicted and avoided while, simultaneously, the operation of the means utilised for binding together the base material can be optimised when manufacturing a product from a base material, preferably in the form of a powder. This object is achieved by means of a device according to claim 1 in the present patent application.

A second object of the invention is to provide a method of the type defined by way of introduction, which method enables defects in the finished product to be predicted and avoided while, simultaneously, the operation of the means utilised for binding together the base material can be optimised when manufacturing a product from a base material, preferably in the form of a powder. This object is achieved by means of a method according to claim 11 in the present patent application.

By means of detecting the errors which may occur in the binding member, there is a possibility to choose the optimum degree in which compensation for these errors should be performed during the production and the type of compensation which is to be performed in such a case. Thereby, there is a possibility to utilise additional information in combination with the knowledge about the detected errors, so that it becomes possible to calculate where the resulting defect will end up in the finished product in question if no compensation is performed and, consequently, there is a possibility to prioritise and adjust the compensation operation to particularly critical positions in the product.

Further advantages and features of the invention will become apparent from the following description and the attached dependent claims.

### BRIEF DESCRIPTION OF THE DRAWINGS

A description in greater detail of exemplifying embodiments of the invention will follow below with reference to the attached drawings.

In the drawings:

FIG. 1 is a schematic top view of a device according to the invention;

FIG. 2 is a schematic view according to FIG. 1, illustrating the binding member and the detecting unit of the device in greater detail; and

FIG. 3 is a schematic cross-sectional view of FIG. 1, illustrating the base material layers present in this cross-section and defects present in these layers.

### DETAILED DESCRIPTION OF PREFERRED EMBODIMENTS OF THE INVENTION

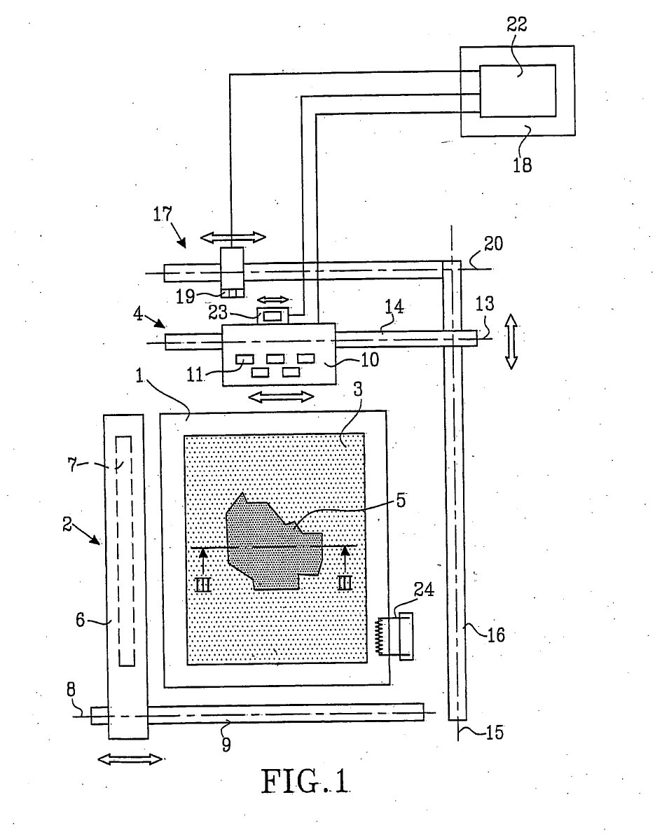

FIG. 1 is a schematic top view showing a support 1, a means for applying superimposed layers of a base material 3, preferably in the form of a powder but applications with a base material in the form of a liquid are also possible, on the support 1, and a member 4 for binding together the base material 3 in selected portions 5 of the base material 3 in order to form a continuous product from the powdered material. The application means 2 is designed for depositing the base material 3 on the support 1 in thin layers. In order to realise the deposition, the application means 2 can exhibit e.g. a container 6 with a nozzle 7 (indicated with a dashed line in FIG. 1) directed towards the support 1, in the form of an aperture through which base material can be applied on the support or on preceding base material layers. Furthermore, in this embodiment, the application means 2 and the support 1 are arranged in a mutually displaceable way, by means of the application means 2 being displaceable along a first axis 8 along a first rail 9, suitably by means of a motor and the requisite control equipment, with the object of applying the base material 3 during relative displacement of the application means 2 and the support 1.

However, it should be emphasised that the design of the application means 2 is not critical for implementing the invention, and that its design accordingly can be varied in a number of ways within the scope of the invention. For example, the application means can exhibit a scraper for a subsequent levelling of the applied powder material.

The binding member 4 and the support 1 are arranged in a mutually displaceable way in order to transfer energy to and/or deposit a medium in different positions of the base material by means of the binding member. The design of the binding member 4 is dependent on the method which is used for creating the final product.

These methods can be divided into three different main groups:
1. The binding member transfers thermal energy in the form of heat radiation, laser light, UV-light, or the like to the base material in the selected portions in order to cure, melt and/or sinter together the base material, for example a powder, into a solid product.
2. The binding member deposits a medium on the base material in the selected portions, such as a binding agent which binds together the powder granules, e.g. by means of gluing. In some cases, this binding can be supplemented with a subsequent treatment for additional curing of the binding agent.
3. The binding member deposits a medium on the base material in the selected portions which does not bind together the base material, but which prepares the base material in such a way that a binding of the base material is enabled in a subsequent treatment. The subsequent treatment can be e.g. heating of the base material, wherein the powder granules of the prepared portions are bonded together by means of adhesion, sintering or melting. Instead, it is also possible to prepare the other portions of the base material, which are not desired to be bonded together, in order to bind together the selected portions in the subsequent treatment whereas said other prepared portions remain non-bonded as a result of the deposited medium.

No matter which the method used for binding together the base material is, it is very important that the binding does not create defects in the product which could influence its structural strength in an unacceptable way.

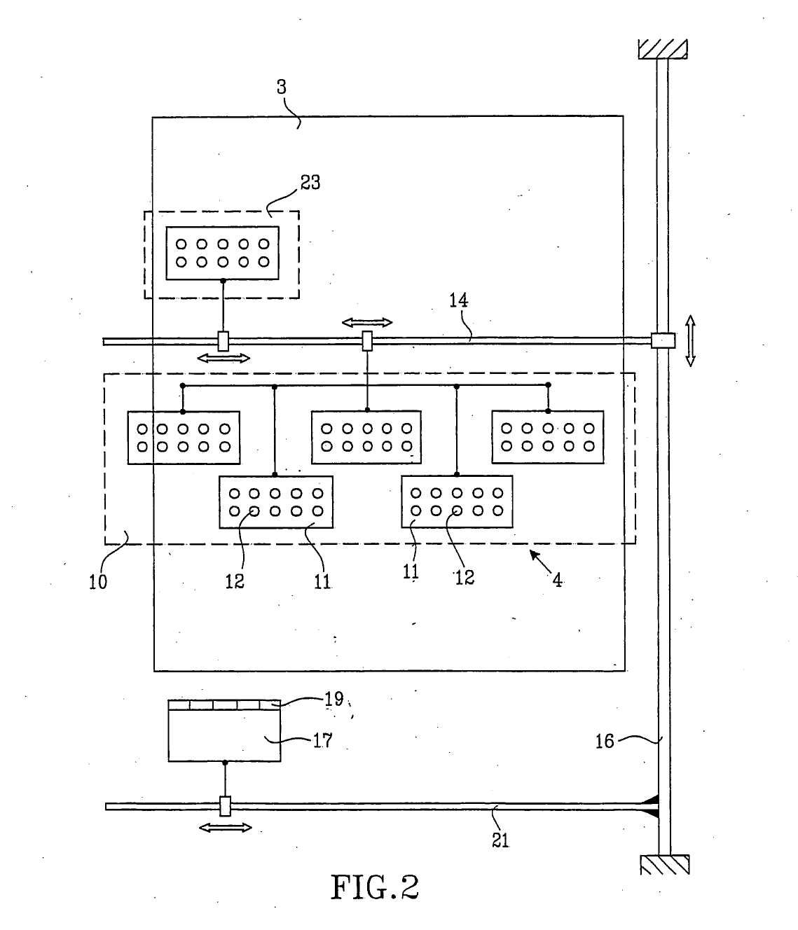

The binding member 4 in the illustrated embodiment comprises a device 10 for depositing a medium on the base material 3. The deposition can take place within said selected portions 5 in order to substantially immediately accomplish the binding of the base material, or in order to prepare the base material so that a binding of the base material in a subsequent treatment is enabled or, alternatively, within those areas of the base material which are outside said selected portions 5 in order to prevent binding in a subsequent treatment. The depositing device 10 can include a set of nozzles arranged in one or several arrays 11. In this embodiment, the depositing device includes a plurality of such arrays provided with nozzles 12 for emitting one or several media onto the base material 3. These nozzles 12 are illustrated schematically by means of two rows of circles in each respective array in FIG. 2.

The support 1, and thereby also the base material 3, and the binding member 4 are arranged in a mutually displaceable way in order to accomplish the binding in different positions of the base material 3. For this purpose, in the embodiment shown in FIG. 1, the binding member 4 can be displaced, suitably by means of a motor and associated control equipment, along a second axis 13 along a second rail 14, which second rail 14 in its turn can be displaced along a third axis 15 along a third rail 16 in a direction substantially perpendicular to the displacement direction of the binding member 4 along said second rail 14. In this way, the binding member 4 and the support 1 are arranged in order to be mutually displaceable in two dimensions in a plane parallel to the support, and thereby the energy transfer or the deposition of the medium can be performed in optional positions of the base material surface.

Suitably, the support is vertically adjustable in relation to the binding member 4 and the applicator means 2 in order to be capable of maintaining the distance in a vertical direction (see FIG. 1), i.e. in a direction perpendicular to the extension of the paper, between the binding member 4 and the uppermost base material layer, and also between the applicator means 2 and the uppermost base material layer, when performing repeated application of base material layers.

Furthermore, the device can be provided with a means 24 for transferring heat to the base material. The heat transfer means 24 can be placed, for example, inside the support 1 as a heating coil for selective heating of said selected portions 5 or of the base material as a whole.

Furthermore, the device includes a unit 17 according to the invention for detecting errors in the binding member 4, and a means 18 according to the invention for compensating for such errors, on the basis of detected errors, in a subsequent energy transfer to and/or deposition on the base material 3. The detecting unit 17 can be constituted of an optical instrument, such as one or several photocells 19, and is suitably arranged in order to be displaceable along a fourth axis 20 along a fourth rail 21 parallel to the displacement direction of the binding member 4 along said second axis 13. In this way, the detecting unit 17 and/or the binding member 4 can be displaced in such a way that they can be located in relative positions enabling an assessment of the function of the binding member 4 by means of the photocell/photocells 19 of the detecting unit 17.

Thereby, the compensating means 18 is suitably provided with a control equipment 22, which communicates with the binding member 4 and the detecting unit 17, and which is arranged to emit/receive signals to/from the detecting unit 17 and/or the binding member 4 for setting appropriate relative positions of the detecting unit 17 and the binding member 4 when detecting errors in the binding member 4.

The compensating member 18 can be arranged for displacing the relative positions and/or orientations of the binding member 4 and the base material 3 in at least one direction in order to compensate for said detected errors, i.e. for displacing the relative positions and/or orientations of the binding member and the base material in one or several of six degrees of freedom (defined by three axes of translation and three axes of rotation) in order to compensate for said detected errors. In the illustrated embodiment, the compensating means 18 is arranged for displacing the relative positions of the binding member 4 and the base material 3 in a direction substantially perpendicular to the direction in which relative displacement of the binding member 4 and the base material 3 takes place during said energy transfer to and/or deposition on the base material. This means that the compensating means 18 is arranged for compensating for the detected errors in the binding member 4, on the basis of information from the detecting unit 17 and the binding member 4, by means of emitting control signals for adjusting the position of the binding member 4 along the second axis 13, i.e. in relation to the base material 3, so that when displacing the binding member 4 along the third axis 15, during energy transfer or deposition of the medium from the depositing device 10 of the binding member 4, it is ensured that energy transfer to and/or deposition on the base material takes place in the desired positions of the base material 3.

Accordingly, the compensation can be accomplished by means of an adjustment, e.g. in the form of a fine-adjustment, of the binding member 4 along said second axis 13. It is possible to perform this adjustment by means of the regular displacement gear for displacing the binding member 4 along said second axis 13, and/or by means of a separate displacement gear which can exhibit a smaller displacement range but which allows a more accurate adjustment than the regular displacement gear. Alternatively, or in combination with the above mentioned methods for compensation, one or several additional binding members 23 can be utilised for compensating for errors in the binding member 4 and eliminating defects in the final product.

In FIGS. 1 and 2, such an additional binding member 23 is arranged in a displaceable way in relation to the binding member 4 in a direction parallel to said second axis 13.

The displacement of the binding member 4 in relation to its normal position in relation to the base material 3 which is performed for the compensation is often of the magnitude of one or a few pitches and up to a few hundred pitches, wherein a pitch defines the resolution with which it is possible to treat the base material by means of the binding member 4.

FIG. 2 is a schematic representation of the different displacement alternatives for the binding member 4, the additional binding member 23, and the detecting unit 17. The connections from the binding member 4 and the detecting unit 17 to the compensating means 18, and the compensating means 18 itself, are not shown in FIG. 2.

When utilising the method according to the invention, layers of a preferably powdered base material are applied on top of each other, and in selected portions of the base material this is bonded together into a continuous product by means of using the binding member 4, wherein the base material 3 and the binding member 4 are displaced mutually in accordance with a selected motion pattern in order to transfer energy to or deposit a medium in different positions of the base material by means of the binding member 4 and, furthermore, in accordance with the method according to the invention, errors in the binding member are detected and, on the basis of the detected errors, compensation for such errors is performed during subsequent energy transfer to and/or deposition on the base material. Within the scope of this, the method can be varied in may different ways. From now on, above all, three different variants which are advantageous for different applications will be described.

According to one embodiment of the method according to the invention, after accomplished displacement in accordance with said selected motion pattern, one or several additional such displacements including said compensation are performed before subsequent layers of base material are applied on the preceding base material layer. This is done if errors in the binding member 4 are detected, and these errors probably have caused one or several unacceptable defects in the product. Thereby, the binding member 4 is brought to scan over the base material layer 3 in the same motion pattern as in the preceding energy transfer or deposition, but while compensation is performed by means of the binding member being slightly displaced, advantageously in a direction perpendicular to the displacement direction of the binding member during the displacement in relation to the base material, in relation to the previous motion pattern.

In accordance with another embodiment of the method according to the invention, after accomplished displacement in accordance with said selected motion pattern, one or several additional layers of base material are applied on the preceding base material layer before another such displacement including said compensation is performed. This is done if errors in the binding member 4 are detected and these would cause one or several unacceptable defects in the product in case the energy transfer or the deposition repeatedly are performed with errors present in the binding member 4. This method is suitable for use if the errors arise in less defect-sensitive areas, where it is still desirable to avoid that the errors repeat themselves and turn up again substantially in the same positions in the X, Y-plane, i.e. in a plane parallel to the support 1, at different positions vertically (perpendicularly to the extension of the paper).

In accordance with still another embodiment of the method according to the invention, an additional binding member 23, displaceable in relation to said binding member 4, is utilised for accomplishing said compensation. This is suitable if errors in the binding member 4 have been detected, and these probably may have caused unacceptable defects in the product in defect-sensitive areas and, simultaneously, there are demands for a high production rate. By means of adjusting the additional binding member in relation to the main binding member 4 so that said additional binding member 23 is arranged in the defect-sensitive area and/or where the main binding member 4 exhibits errors, it can be compensated in advance for errors and without requiring that the binding member scans two or several times across the same base material layer with substantially the same motion pattern.

In case too many errors are detected in the binding member 4 so that a desired result cannot be obtained in spite of the compensation possibility, suitably some kind of automatic or manual restoration is utilised, e.g. cleaning of nozzles, of positions of the binding member which are out of order, and/or exchange of parts of the binding member or the binding member in its entirety.

The optical gauge 17, 19 can be arranged at the binding member 4 for detecting a presence or an absence of energy emitted from the binding member 4, or alternatively a presence or an absence of the medium emitted from the depositing device 10 included in the binding member at one or several of the nozzles 12. When detecting emitted medium, the gauge can be arranged for determining at least one property of the medium related to the function of the depositing device 10 when such medium is present. Thereby, the properties of the droplets of medium can be measured, such as size, direction, velocity, and/or time delay between the control signal for generating a droplet and the actual generation of the droplet. Measurements can be performed in one position or simultaneously in several positions and, by means of stepwise displacement of the detecting unit 17 in relation to the binding member 4, detection and associated measurements can be performed in all positions of the binding member.

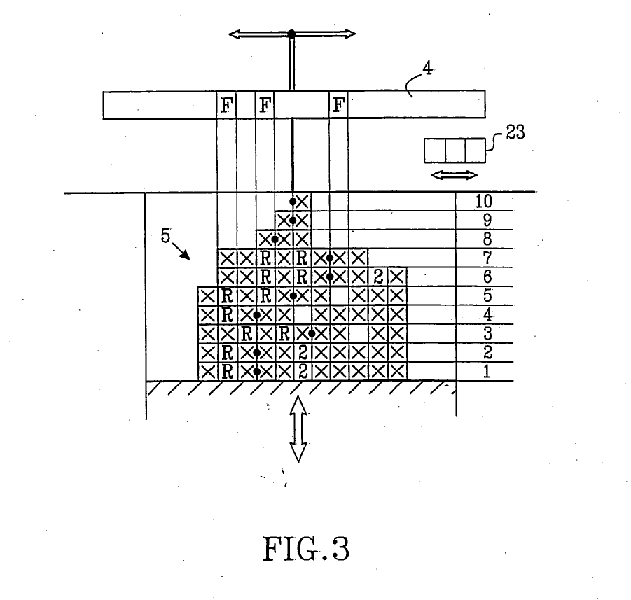

FIG. 3 is a highly schematic representation of a product which has been approved in accordance with certain given criteria, and the different methods utillsed in order to obtain this product. FIG. 3 can be regarded as a partial cross section of a device according to claim 1. The binding member 4, exhibiting three defective positions F in this cross section, and an additional binding member 23, exhibiting three positions to be used for compensation, are located above the deposited base material layers (numbered 1-10).

Other device limitations are assumed to be that the binding member 4 is displaceable ±2 positions, whereas the additional binding member 23 is displaceable along the main binding member 4 in its entirety.

The different base material layers illustrated with squares are, schematically, divided into units which can be treated by a corresponding position in the array of the binding member 4.

The demands made on the product before it can be granted approval are assumed to be that there are no long through-areas which are non-treated, and that all external surfaces should exhibit at least two flawless units directly inside these. The scans by means of the binding member in the intended motion pattern are performed repeatedly in a direction perpendicular to the extension of the paper.

In FIG. 3, the following reference marks have been used:
F=errors in a position of the main binding member 4,
X=the main binding member 4 has performed the requisite energy transfer to or deposition of medium on the base material layer in question,
R=the additional binding member 23 has performed the requisite energy transfer to or deposition of medium on the base material in question,
2=the position has been treated by means of the binding member or the additional binding member in a second scan across the same position,
●=the location of the centre of the binding member 4 during each respective scan.

On the right hand side of FIG. 3, the base material in question is listed. Layers 1 and 2 require two scans, since these layers have to be flawless in accordance with the given criteria. In layers 3, 4 and 5, both the additional binding member 23 and compensation by means of displacing the binding member 4 between the layers are utillsed. This results in non-treated positions (empty units in FIG. 3) in non-sensitive positions. In layer 6, both two scans and the additional binding member 23 are utilised. In layer 7, there is a sufficient compensation by means of the additional binding member 23, and finally, in layers 8, 9, 10 it is sufficient to compensate by means of displacing the main binding member 4.

1. A device for manufacturing a product from a base material, comprising a means (2) for applying superimposed layers of base material (3) on a support (1) and a member (4) for binding together the base material in selected portions (5) of the base material in order to form a continuous product from the base material, wherein the support, and thereby the base material, and the binding member are arranged in a mutually displaceable way in order to transfer energy to and/or deposit a medium in different positions of the base material by means of the binding member,
wherein the device includes a unit (17) for detecting errors in the binding member (4), and a means (18) for compensating for such errors on the basis of detected errors in subsequent energy transfer to and/or deposition on the base material (3).

2. Device according to claim 1, wherein the compensating means (18) is arranged for displacing the relative positions and/or orientations of the binding member (4) and the base material (3) in at least one direction in order to compensate for said detected errors.

3. Device according to claim 2, wherein the compensating means (18) is arranged for displacing the relative positions of the binding member (4) and the base material (3) in a direction substantially perpendicular to the direction in which relative displacement of the binding member and the base material takes place during said energy transfer to and/or deposition on the medium.

4. Device according to claim 1, wherein the detecting unit (17) comprises an optical instrument (19) for detecting said errors in the binding member (4).

5. Device according to claim 1, wherein the binding member (4) includes a device (10) for depositing the medium on the base material within said selected portions (5) in order to substantially immediately accomplish the binding of the base material (3) or for preparing the base material so that a binding of the base material in a subsequent treatment is enabled.

6. Device according to claim 5, wherein the depositing device (10) exhibits a plurality of nozzles (12), arranged in one or several arrays (11), for emitting the medium.

7. Device according to claim 1, wherein the device includes a means (24) for transferring heat to the base material.

8. Device according to claim 4, wherein said optical instrument (19) is an optical gauge arranged at the binding member (4) for detecting a presence or an absence of energy emitted from the binding member.

9. Device according to claim 4 wherein said optical instrument (19) is an optical gauge arranged at the depositing device (10) for detecting a presence or an absence of medium emitted from the depositing device at one or several of the nozzles (12).

10. Device according to claim 9, wherein the optical gauge (19), in the presence of emitted medium, is arranged for determining at least one property of the medium which is related to the function of the depositing device.

11. A method for manufacturing a product from a base material, comprising:
to apply layers of base material (3) on top of each other;
to bind the base material together in selected portions thereof into a continuous product by means of using a binding member (4),
wherein the base material and the binding member are displaced mutually in accordance with a selected motion pattern in order to transfer energy to and/or deposit a medium in different positions of the base material by means of the binding member,
wherein errors in the binding member are detected, and that compensation for such errors, on the basis of detected errors, is performed in subsequent energy transfer to and/or deposition on the base material.

12. Method according to claim 11, wherein the relative positions and/or orientations of the binding member (4) and the base material (3) are displaced in at least one direction in order to accomplish said compensation.

13. Method according to claim 12, wherein the relative positions of the binding member (4) and the base material (3) are displaced in a direction substantially perpendicular to the direction in which relative displacement of the binding member and the base material takes place in accordance with said selected motion pattern during said energy transfer to and/or deposition on the base material.

14. Method according to claim 11, wherein one or several additional such displacements including said compensation are performed after an accomplished displacement in accordance with said selected motion pattern, before subsequent layers of base material are applied on the preceding base material layer.

15. Method according to claim 11, wherein one or several additional layers of base material is/are applied on the preceding base material layer after an accomplished displacement in accordance with said selected motion pattern, before another such displacement including said compensation is performed.

16. Method according to claim 11, wherein the base material is bonded together, or prepared in such a way that a binding of the base material in a subsequent treatment is enabled, by means of depositing the medium on the base material within said selected portions by means of a depositing device (10) included in the binding member.

17. Method according to claim 16, wherein a presence or an absence of medium emitted from the depositing device (10) is detected at one or several positions of the depositing device in order to detect said errors in the binding member (4).

18. Method according to claim 17, wherein at least one property of the medium which is related to the function of the depositing device (10) is determined in the presence of emitted medium.

19. Method according to claim 11, wherein a presence or an absence of energy emitted from the binding member is detected at one or several positions of the binding member (4) in order to detect said errors in the binding member.

20. Method according to claim 11, wherein an additional binding member (23), displaceable in relation to said binding member (4), is utilised in order to accomplish said compensation.

21. Method according to claim 20, wherein the relative positions and/or orientations of said additional binding member (23) and said binding member (4) are adjusted on the basis of said detected errors in order to accomplish the compensation.

22. Method according to claim 21, wherein the relative positions of said additional binding member (23) and the binding member (4), along an extension in a direction substantially perpendicular to the direction in which relative displacement of the binding member and the base material takes place during said energy transfer to and/or deposition on the base material, are adjusted on the basis of said detected errors in order to accomplish the compensation.

23. Method according to claim 11, wherein heat is transferred to the base material in order to accomplish the binding.

24. Method according to claim 23, wherein thermal energy is transferred to said selected portions of the base material in order to accomplish the binding.
